(19) United States
(12) Patent Application Publication
(10) Pub. No.: US 2005/0007990 A1
(43) Pub. Date: Jan. 13, 2005

(54) Method for allocation of transmission channels in a mobile radio cell for a multicast service

(76) Inventors: Mark Beckmann, Braunschweig (DE); Michael Eckert, Braunschweig (DE); Martin Hans, Hildesheim (DE); Andreas Otte, Celle (DE)

Correspondence Address: BELL, BOYD & LLOYD, LLC, P. O. BOX 1135, CHICAGO, IL, 60690-1135, US

(21) Appl. No.: 10/497,938

(22) PCT Filed: Nov. 8, 2002
(86) PCT No.: PCT/DE02/04138

(30) Foreign Application Priority Data
Dec. 5, 2001 (DE) 101 59 637.5

(51) Int. Cl. H04J 3/24; H04L 12/66; H04L 12/28; H04L 12/56

(52) U.S. Cl. 370/349; 370/352; 370/392

(57) ABSTRACT

A method is provided for allocating physical transmission channels in a mobile radio cell, in which a base station, linked with a node of a mobile communication network; and a number of mobile terminals are present. In all mobile terminals and in the node of the mobile communication network the UMTS protocol architecture is implemented for at least the layer (2) and the layer (3) of the UMTS layer model. In at least one group of mobile terminals the physical transmission channel to be used for a multicast service is signaled for every mobile user terminal from the base station of the mobile radio cell. The present invention seeks to make the allocation of physical transmission channels in a mobile radio cell for a multicast service more efficient. Signaling of the allocation of a physical transmission channel to one of the mobile user terminals of the group from the node of the mobile communication network is carried out via the base station to the mobile user terminal by a general physical channel and system information is made available in advance to the group of mobile user terminals. The system information contains the configurations of the physical transmission channels for the multicast service and of the general physical channel. The system information further contains the information that the signaling of the allocation of the physical transmission channels is carried out on the general physical channel.

### BACKGROUND OF THE INVENTION

The present invention relates to a method for allocation of physical transmission channels in a mobile radio cell, in which a base station which is connected to a node in a mobile communications network and a number of mobile terminals are located, with the UMTS protocol architecture for at least the layer 2 and the layer 3 of the UMTS layer model being implemented in all of the mobile terminals and in the node in the mobile communications network, and with the respective physical transmission channel to be used for a multicast service being signaled from the base station in the mobile radio cell for each mobile terminal in at least one group of mobile terminals.

A method such as this is known, for example, from WO 00/35225 A1. Further relevant information can be found in the standard document “ETSI TR 125 925 V3.4.0 (2001-03) entitled “Universal Mobile Telecommunications System (UMTS); Radio Interface for Broadcast/Multicast Services (3GPP TR 25.925 version 3.4.0 Release 1999). Reference should be made, in particular, to Section 6.3.5.1 there, which relates to functions of the RRC instance at the UTRAN end, as well as to the dissemination of system information for the purposes of a broadcast service.

In order to explain the known method mentioned above, reference should be made to layer 2 and the lower layer 3 of the UMTS protocol architecture. In this context, reference is made to the literature reference 3 GPP TS 25.301, “Radio Interface Protocol Architecture”. The protocol architecture includes the protocols for the UMTS air interface and is present not only in a mobile terminal but also in a node in the mobile communications network (“RNC”); that is to say, each of the protocols exists on the one hand in the mobile terminal (“UE”) and on the other hand in the node in the mobile communications network.

Identical protocols interchange protocol data units (“PDU”) by using the services of the protocol layers which are arranged underneath them for transportation of the protocol data units. Each protocol layer offers its services to the protocol layer above it at so-called service access points. These service access points are provided with generally conventional and unambiguous names in order to understand the protocol architecture better, for example “logical channels,” “transport channels,” and “radio bearer.” For data transfer, protocols receive service data units (“SDU”) at their service access points and pass protocol data units produced from them to the layer below them, so that protocol data units from a specific protocol layer are thus identical to the service data units from the layer underneath them.

In a mobile terminal for UMTS, data may be produced by various applications. This data first of all may be modified by protocols from higher layers, and may be prepared for data transfer in different networks. For transportation via the UMTS air interface, this data must be optimized in the various protocols in layer 2 (PDCP, RLC and MAC). The service access point at which non-UMTS-specific protocols can use the transmission service of the UMTS air interface is referred to as a radio bearer (“RB”).

One object of the RLC protocol is to split or join together the datastream into packets, which have an optimum length for the air interface. Furthermore, the RLC protocol layer stores data at a radio bearer in an RLC buffer until it can be transported via the air interface by layers below the RLC protocol layer. The RLC protocol layer has further tasks; in particular, to carry out error correction.

The RLC protocol layer passes the resultant RLC protocol data units to the MAC layer for further transmission. The RLC protocol layer is, in this case, designed such that there is a separate RLC entity for each radio bearer.

The service access points at which the MAC protocol layer provides its services are referred to as “logical channels.” There is one, and only one, RLC entity for each radio bearer, and either one or two logical channels both for the uplink direction and for the downlink direction. Logical channels differ by the type of data that is transmitted on them.

The object of the MAC protocol layer in the transmitter of a base station in a mobile radio cell is to map the data on a logical channel above the MAC protocol layer onto the transport channels in the physical layer, and, in the receiver, its object is to distribute data received on transport channels between logical channels. Each transport channel normally is, for this purpose, preconfigured with a set of fixed parameters for transmission of data. The MAC protocol layer can search through a further set of variable parameters for the best parameters in each case for the present transmission, and thus can influence data transmission dynamically. A valid setting of all the parameters for a transport channel is referred to as a “transport format” (“TF”). The set of all possible settings for a specific transport channel is referred to as a “transport format set” (“TFS”). Within a transport format set, only the variable or dynamic parameters of the transport format vary for the relevant transport channel. Only one transport format is set at any given time for each individual transport channel. The set of transport formats which are set for all of the existing transport channels at a given time is referred to as a “transport format combination” (“TFC”). The transport formats which are valid for each transport channel result in a very large number of possible combinations for all of the transport channels. In theory, each of these combinations may result in a transport format combination. However, in practice, the number of actually permissible combinations of transport formats is restricted. The set of all the permissible transport format combinations for a number of transport channels is referred to as a “transport format combination set” (“TFCS”). Within a transport format set, individual transport formats can be referenced via an index, the so-called “transport format identifier” (“TFI”). A similar situation also applies to a transport format combination set, with the index which is used in this context and which uniquely indicates a specific transport format combination being referred to as a “transport format combination identifier” (“TFCI”).

The setting up, clearing and reconfiguration of transport channels and radio bearers, and the negotiation of all the parameters for the protocols in layer 2 are governed by the RRC protocol. This protocol is present not only in the mobile terminal but also in the node in the mobile communications network, and uses the transmission services which the RLC layer provides, that is to say the logical channels, in order to transmit RRC messages. The various protocols for layer 2 are then configured via the transmission parameters negotiated between the RRC protocols. For example, a transport format set can be negotiated for setting up or reconfiguration of each transport channel between the RRC protocols for the mobile terminal on the one hand and for the node in the mobile communications network on the other hand, on the basis of which the transport format combination set which is valid for all of the transmission channels is transmitted. This transport format combination set is thus predetermined for the MAC protocol layer by the RRC protocol layer. The MAC layer can then select a specific transport format combination from the transport format combination set for the relevant transport channels. The MAC protocol layer signals to the bit transmission layer the choice of a transport format for a specific transport channel, in which it transmits the appropriate transport format identifier.

The multiplexing, coding and puncturing processes which are carried out within the bit transmission layer are carried out in a manner which is defined uniquely by a transport format combination. Thus, for example, the index of the current transport format combination is transmitted from the node in the mobile communications network to a mobile terminal. To do this, the bit transmission layer deduces from the transport format identifiers which are transmitted by the MAC protocol layer which specific transport format combination has currently been selected, and uses the respective physical channel to transmit the transport format combination identifier, from which the individual transport format identifiers, and thus the transport formats, can be reconstructed at the respective receiver end. For an even more detailed description of the functional relationships relating to the UMTS protocol architecture, reference should be made to the text book “Mobilfunknetze und Ihre Protokolle, Grundlagen, GSM, UMTS und andere zellulare Mobilfunknetze” [Mobile radio networks and their protocols, Fundamentals, GSM, UMTS and other cellular mobile ratio networks], Volume 1, third edition, by B. Walke, August 2001, published by Verlag B. G. Teubner; in particular, Chapters 5.8 and 5.9.

The procedure for providing a multicast service based on the functional relationships described above is as follows: common physical channels are used as resources for the transmission of multicast messages in the downlink direction (in contrast to dedicated channels in the downlink direction, which are allocated to specific mobile terminals). Each mobile terminal is allocated a dedicated physical channel for the downlink (DL DPCH), via which the current transport format combination identifier is transmitted from the node in the mobile communications network via the base station to a mobile terminal. The transport format combination identifier includes information which firstly indicates the physical resources in the form of common physical channels for the downlink, and secondly indicates the transport format combination for the common physical channels for the downlink.

For example, when setting up a radio bearer, a mobile terminal is, for this purpose, signaled with information as to which common physical channels in the downlink are allocated to a specific value for the transport format combination identifier, and which transport format combination is allocated to the transport format combination identifier.

If a mobile terminal has been allocated a common transport channel for the downlink, then, in each time frame, it receives the associated common physical channel on the downlink. Within the time frame, which includes payload data and the transport format combination identifier, the mobile terminal evaluates the field for the transport format combination identifier which has been transmitted on this channel. The mobile terminal uses this information to decide whether and on which common physical channels for the downlink it must listen as resources in the next time frame.

In this method for allocation of resources to mobile terminals in a mobile radio cell, it is regarded as being disadvantageous that it be necessary to signal separately to each individual mobile terminal what resources in the form of common physical channels for the downlink it should use for a multicast service.

Against this background, the present invention is directed to providing a method of the type mentioned initially, in which physical transmission channels can be allocated more efficiently in a mobile radio cell for a multicast service.

### SUMMARY OF THE INVENTION

In contrast to the prior art, on the basis of the method of the present invention, each mobile terminal is not individually signaled as to which physical resources in the form of physical transmission channels it should use for a multicast service. In fact, the allocation is advantageously signaled via a common physical channel for the downlink; preferably, via the S-CCPCH channel which is defined for UMTS.

All the other information which is required for handling multicast messages is already known by each mobile terminal from some other source, in which case, in particular, the system information which is transmitted periodically in the normal way may include the necessary information. In detail, each mobile terminal must be able, for example on the basis of the system information, after receiving a message via the general physical channel as to which physical channel should be used for a multicast service, to make the necessary configuration settings for a processing to be carried out on a received multicast message. This includes, for example, the setting to the physical transmission channel to be used and the transport format as predetermined by the node in the mobile communications network.

The signaling allocation of a physical transmission channel to one of the mobile terminals can be carried out for all of the mobile terminals in the mobile radio cell. However, it is also possible to signal only those mobile terminals which belong to a group that has the capability to use a multicast service. For this purpose, the system information may include a code for identification of the group of mobile terminals as a multicast group. This can be used to transmit a code that is specific for the multicast group via the general physical channel in order to signal the allocation of a physical transmission channel for multicast messages, via which code each mobile terminal can determine whether a multicast message to be expected is intended for that mobile terminal.

The present invention provides for a continuously updated transport format combination identifier to be transmitted periodically via the general physical channel to the group of mobile terminals, indicating which transport channels are being mapped via which transport format combination onto the general physical channel, which mobile terminal should use which physical transmission channel for the multicast service, and which transport channels are being mapped via which transport format combination onto the respective physical transmission channel.

To this extent, the transport format combination identifier for the general physical channel as explained above is used to allocate physical transmission channels for multicast mess ages, in order to carry out the necessary, current signaling actions for the mobile terminals in a mobile radio cell. In particular, the transport format combination identifier may be subdivided and may have a first data part, which includes a transport format combination identifier for the transport channels which are mapped onto the general physical channel, a second data part which includes a transport format combination identifier for the transport channels which are mapped onto the physical transmission channel, and a code for identification of the physical transmission channel being used by a respective mobile terminal.

The second data part of the transport format combination identifier thus includes the necessary signaling for the mobile terminals with respect to the allocation of the resources, including the transport format information which a mobile terminal requires in order to make it possible to further-process a multicast message received on the allocated physical transmission channel.

The subdivision of the transport format combination identifier into the first data part and the second data part either may be fixed or may be variable. In the former case, details about the number of bits which relate to the general physical channel for signaling and about the number of bits which relate to the signaling itself can be transmitted to each mobile terminal in a mobile radio cell via the system information. If the subdivision of the transport format combination identifier is variable, the second data part may include information as to how the subdivision of the bits between the first data part and the second data part is selected.

The general physical channel for signaling of the resources is advantageously sent at a time before the physical transmission channels for the multicast messages. As such, the mobile terminals which are affected by the multicast messages can carry out the necessary configuration processes for their protocol layers before reception of the physical transmission channels.

The method according to the present invention allows the allocation of resources for a multicast service to mobile terminals within a mobile radio cell to be updated time frame by time frame. This is particularly advantageous in the case of short transmissions, small amounts of data and data traffic that occurs in groups.

The transport channels which are allocated to the general physical channel are advantageously combined in a first bundle in the bit transmission layer, and the transport channels which are allocated to the physical transmission channels are advantageously combined in a second bundle in the bit transmission layer. In this context, it should be noted that, within the bit transmission layer, there is an internal channel which is referred to as “CTTrCH.” This channel is mapped onto one or more physical channels.

It is possible to provide that only mobile terminals which belong to a multicast group use the general physical channel for signaling allocations of resources via the subdivided transport format combination identifier. This has the advantage that mobile terminals which do not belong to a multicast group or do not have the capability to receive multicast services can ignore the subdivision of the transport format combination identifier.

Additional features and advantages of the present invention are described in, and will be apparent from, the following Detailed Description of the Invention and the Figures.

### BRIEF DESCRIPTION OF THE FIGURES

FIG. 1 shows a block diagram illustration to show state transitions in a mobile terminal in conjunction with the reception of a multicast message.

FIG. 2 shows a schematic illustration of a mobile radio cell in which a number of mobile terminals are located, in conjunction with a node in a mobile communications network.

FIG. 3 shows a detail from a UMTS protocol architecture.

FIG. 4 shows a schematic illustration of the time sequence of time frames for a general physical channel for allocation of resources, and a transmission channel for multicast messages.

### DETAILED DESCRIPTION OF THE INVENTION

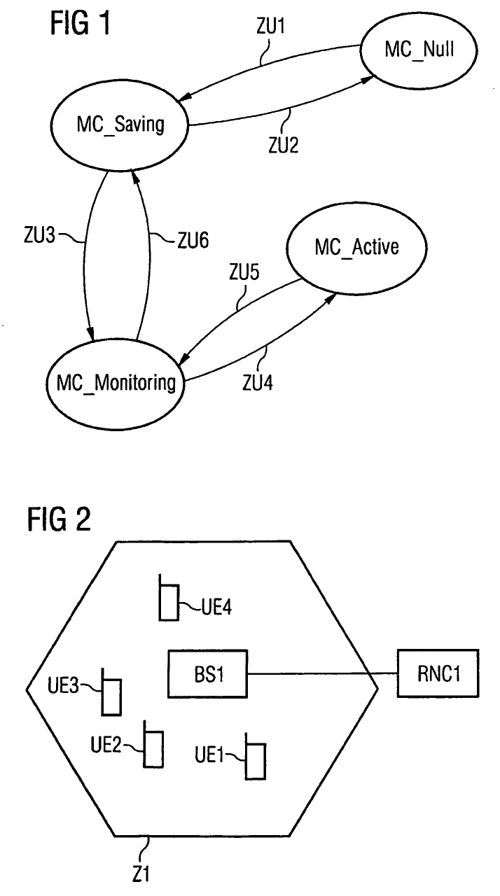

In conjunction with the reception of multicast messages on a physical channel, one of a total of four states occur at any given time in a mobile terminal, and these are annotated in FIG. 1 with the reference symbols MC_0, MC_Saving, MC_Monitoring and MC_Active. The first state MC_0 is characterized in that the relevant mobile terminal does not belong to a multicast group. In addition, the mobile communications network does not attempt to inform the mobile terminal when a multicast message is awaiting transmission from a node in the mobile communications network to that mobile terminal.

The second state MC_Saving of the mobile terminal is defined in that the mobile terminal belongs to a multicast group, in that the mobile terminal reads broadcast messages, in that the mobile terminal is monitoring the notification channels PICH and PCH, and in that the mobile communications network notifies the mobile terminal via the notification channels PICH and PCH when a multicast message is awaiting transmission. The second state MC_Saving corresponds to the RRC states Idle Mode, Cell_PCH and URA_PCH defined for UMTS.

The third state MC_Monitoring of the mobile terminal is characterized in that the terminal belongs to a multicast group, there is a signaling link between that mobile terminal and the node in the mobile communications network RMC, and the mobile terminal receives and analyzes the transport format combination identifier in each time frame, with this transport format combination identifier being transmitted on a general physical channel S-CCPCH which is configured for multicast signaling.

The third state MC_Monitoring corresponds to the RRC state CELL_Fach or CELL_DCH.

The fourth state MC_Active of the mobile terminal is characterized in that the mobile terminal belongs to a multicast group and the mobile terminal receives multicast messages on the physical channels which have been allocated to the multicast group in a previous time frame by the transport format combination identifier for the general physical channel S-CCPCH.

A total of six state transitions ZU1, ZU2, ZU3, ZU4, ZU5 and ZU6 take place between the four states MC_0, MC_Saving, MC_Monitoring and MC_Active of the mobile terminal. These are explained in detail in the following text.

For the state transition ZU1 from the first state MC_0 to the second state MC_Saving, the mobile terminal registers with a first multicast group. The node in the mobile communications network RNC1 signals an identifier for the first multicast group to the mobile terminal. Furthermore, for the state transition ZU1, the configurations of the general transport channels MCH and of the general physical channels PMCH via which multicast messages can be sent to the mobile terminal are signaled to the mobile terminal. Alternatively, the mobile terminal can read the configurations from the system information. Furthermore, for the first state transition ZU1, the mobile terminal is signaled the allocation between a data part of the transport format combination identifier for the general physical channel S-CCPCH, which is intended to be used for signaling of physical transmission channels PMCH and transport channels MCH which are mapped onto the transmission channels PMCH for multicast messages for the transport format combination to be used for the transmission of the multicast message, for the resources to be used in the form of a physical channel PMCH and for the multicast group. Alternatively, the mobile terminal may read this allocation from the system information.

A second state transition ZU2 takes place from the second state MC_Saving to the first state MC_0, and likewise is illustrated in FIG. 1. For the state transition ZU2, the mobile terminal registers with one or more multicast groups. A multicast unit is deleted in the BMC layer in the UMTS protocol architecture.

For a third state transition ZU3, the mobile terminal changes from the MC_Saving second state to the MC_Monitoring third state. For this third state transition ZU3, the mobile terminal is notified by a base station that multicast messages are waiting for the multicast group to which the mobile terminal belongs. Furthermore, the mobile terminal sets up a signaling link to the base station and continuously receives the physical channel S-CCPCH, which includes a subdivided transport format combination identifier TFCI. The subdivision of the transport format combination identifier TFCI will be explained later.

For a fourth state transition ZU4, in which the mobile terminal changes from the third state MC_Monitoring to the state MC_Active, the transport format combination identifier TFCI which is received on the physical channel S-CCPCH indicates that messages for the multicast group to which the mobile terminal belongs are waiting in the next time frame. On the basis of this, the mobile terminal sets up a general transport channel and a general physical channel, in order to receive the multicast messages being waited for, with the selection of which general physical channel should be used of the mobile terminal being made on the basis of the transport format combination identifier TFCI.

A fifth state transition ZU5, in which a state change takes place from the fourth state MC_Active to the third state MC_Monitoring, takes place when the transport format combination identifier TFCI which is received on the physical channel S-CCPCH indicates that there are no multicast messages for the multicast group to which the mobile terminal belongs waiting in the next time frame. The signaling link between the mobile terminal and the node in the mobile communications network is maintained, with the mobile terminal still continuously receiving the general physical channel S_CCPCH.

A sixth state change ZU6 takes place when no multicast messages for the multicast group or groups to which the mobile terminal belongs occur within a specific time. On the basis of this situation, the mobile communications network decides to switch the mobile terminal to a battery-saving state, and clears the signaling link in the form of the physical channel S-CCPCH between the mobile terminal and the mobile communications network (RRC Idle Mode). Alternatively, the mobile communications network can signal to the mobile terminal to change to the RRC state CELL_PCH or URA_PCH.

The following text describes, by way of example, what state changes will take place for four mobile terminals UE1, UE2, UE3 and UE4 in a mobile radio cell Z1 which is covered by a base station BS1; to be precise, on the basis of FIG. 2. The base station BS1 is connected via a land line connection to a node in a mobile communications network RNC1 (RNC stands for “Radio Network Controller”). The node in the mobile communications network RNC1 is, in turn, connected via a further land line connection to a higher unit in the mobile communications network. This is not particularly relevant to the present invention and therefore is not illustrated in FIG. 2.

This exemplary embodiment is based on the assumption that all of the four mobile terminals UE1, UE2, UE3 and UE4 belong to a multicast group A. Furthermore, it is assumed that the mobile terminal UE1 is in the RRC idle mode state. The node in the mobile communications network RNC1 therefore does not know that the mobile terminal UE1 is located in a mobile radio cell which is controlled by the node in the mobile communications network RNC1. However, the mobile terminal UE1 reads system information which the node in the mobile communications network RNC1 distributes throughout the entire mobile radio cell Z1, and regularly receives the notification channel PICH which is provided for UMTS, in order to monitor whether any notifications for the mobile terminal UE1 are being set on the notification channel PCH.

By way of example, it is assumed that the mobile terminal UE2 is in the RRC CELL_PCH state. The mobile terminal UE2 thus also reads the system information, and regularly monitors the notification indication channel PICH.

The mobile terminal UE3 is assumed, by way of example, to be in the RRC CELL_FACH state. Thus, it reads the system information. Furthermore, the mobile terminal UE3 continuously receives on the physical channel S-CCPCH. By way of example, it is assumed that the mobile terminal UE4 is in the RRC CELL_DCH state. In this state, the mobile terminal UE4 does not read any system information. However, any mobile terminal in the mobile radio cell Z1 continuously may receive a general physical channel S-CCPCH.

On the basis of this exemplary embodiment, the system information includes the configurations of two physical channels PMCH1, PMCH2 for transmission of multicast messages. It is also assumed that the configuration of the general physical channel S-CCPCH, which is already defined for UMTS, is included in the system information. The physical channel S-CCPCH has the task of transmitting a subdivided transport format combination identifier TFCI, as well as information that this general physical channel S-CCPCH is currently transmitting the subdivided transport format combination identifier TFCI. This exemplary embodiment is also based on the assumption of variable subdivision of the transport format combination identifier TFCI, for which reason the system information includes further information which indicates how many of the, for example, 10 bits should be used for the signaling of the multicast group, for indication of the transport format combination (TFC) of multicast transport channels MCH which are mapped onto the physical multicast channels PMCH1, PMCH2, and for allocation of the physical multicast channels. In an alternative exemplary embodiment, in which the subdivision of the transport format combination identifier (TFCI) is fixed, such as with five bits in each case, the information as to how many bits are used for the multicast function is not required.

Furthermore, in this exemplary embodiment, the system information also includes the allocations of transport format combination identifiers TFCI for physical multicast channels and transport format combinations.

This exemplary embodiment is based on the assumption that only one multicast transport channel MCH is configured in the mobile radio cell Z1, via which multicast messages are intended to be transmitted. The transport format set TFS is also transmitted in the system information for this multicast transport channel MCH. Since only one multicast transport channel, specifically the channel MCH, is mapped onto the physical multicast channels PMCH1, PMCH2, each transport format TF is a transport format combination at the same time. It is also assumed that only two transport formats have been configured, so that the transport format combinations TFC1 and TFC2 are produced. The transport format combination identifier TFCI_{PMCH} which is allocated to one transport format combination, either TFC1 or TFC2, is transmitted as a part of the transport format combination identifier TFCI on the general physical channel S-CCPCH. The other part of the transport format combination identifier, which is referred to as TFCI_{S-CCPCH}, indicates which transport format combination governs the general physical channel S-CCPCH.

Since only four different values are required for the second data part of the transport format combination identifier, the node in the mobile communications network RNC1 inserts information into the system information that 8 bits of the total of 10 bits are used for the transport format combination identifier for the signaling of the transport format combination identifier TFCI_{S-CCPCH}, and that 2 bits are used for signaling the transport format combination identifier TFCI_{PMCH}. The allocation assumed for this exemplary embodiment is shown in the following table:

| S-CCPCH TFCI | Resources for transmission | Transport format |
|---|---|---|
| part 2 number | of multicast messages | combinations used |
| TFCI1 = 00 | PMCH1 | TFC1 |
| TFCI2 = 01 | PMCH1 + 2 | TFC1 |
| TFCI3 = 10 | PMCH2 | TFC2 |
| TFCI4 = 11 | PMCH1 + 2 | TFC2 |

This system information, which is distributed throughout the entire mobile radio cell Z1, indicates that the mobile terminals UE1, UE2 and UE3 have received all the information which is required for reception of multicast messages. The mobile terminal UE4 does not read the system information since it is in the RRC CELL_DCH state. Alternatively, however, the mobile terminal either may have read the system information before changing to the last-mentioned state or if it is changed via a handover from another source to the mobile radio cell Z1. In the latter case, the node in the mobile communications network RNC1 sends to the mobile terminal UE4 the information which is required for reception of multicast messages together with that information via which the change (handover) was caused to take place from the further mobile radio cell to the cell Z1.

In this way, all of the mobile terminals within the mobile radio cell Z1 know the configuration of the physical channels PMCH for transmission of multicast messages as well as the allocation of transport format combination identifiers to the transport format combination being used, the physical channel PMCH to be used, and the relevant multicast group.

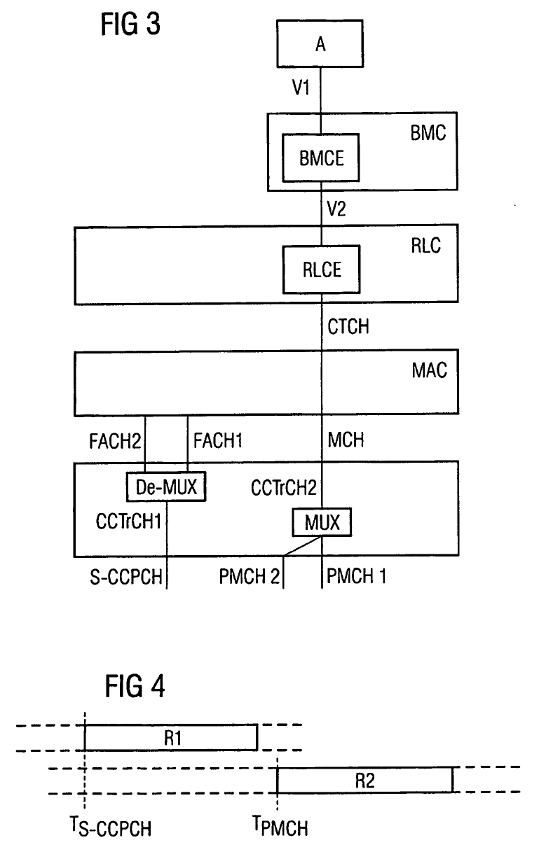

The following text is based on the assumption that an application which uses multicast messages which are sent to the multicast group A is active in the mobile terminals UE1, UE2, UE3 and UE4 which belong to the multicast group A. Once the mobile terminals in the multicast group A have been made aware by the system information that multicast messages for the multicast group A are being transmitted in the mobile radio cell Z1, these mobile terminals set up a BMC unit BMCE in the layer BMC in the protocol architecture for UMTS, which is connected via a link V1 to an application A, as can be seen in FIG. 3. Furthermore, an RLC unit RLCE is set up in the layer RLC in the protocol architecture for UMTS, which is connected via a link V2 to the BMC unit BMCE and, furthermore, uses a logical channel CTCH which is offered by the MAC layer. Furthermore, the MAC layer is connected to the physical layer via the general transport channel MCH for the transmission of multicast messages.

Since the physical channels which are available for the transmission of multicast messages are only notified by the system information, but have not yet been allocated for the transmission of multicast messages to the multicast group A, the available physical channels PMCH have not yet been mapped onto the general transport channel MCH.

Since the mobile terminal UE3 and the mobile terminal UE4 are in the RRC states CELL_FACH and CELL_DCH, respectively, they can, at this stage, continuously receive the general physical channel S-CCPCH, as specified in UMTS, and can evaluate the subdivided transport format combination identifier TFCI which is transmitted on this channel. On the basis of the above state descriptions, the mobile terminals UE3, UE4 are thus in the third MC_Monitoring state.

The mobile terminals UE1, UE2 are in the RRC state idle mode and CELL-PCH, respectively. These mobile terminals monitor the notification indication channel PICH and, if there is any signaling on the PICH that messages are waiting for a specific mobile terminal on the notification channel PCH, such mobile terminal receives the notification channel PCH.

The assumption is now made that a multicast message is intended to be transmitted to the multicast group A. This presupposes that the mobile communications network knows which mobile terminals belong to the multicast group A. The node in the mobile communications network RNC1 receives information about which mobile radio cells the mobile terminal UE1 is supposed to be in. The node in the mobile communications network RNC1 can obtain this information in the course of administration of the mobile terminals associated with it, including the terminal U1. The node RNC1 in the mobile communications network now sends information on the notification indication channel PICH to all the mobile radio cells which are associated with that node RNC1 in the mobile communications network, and in which the mobile terminal UE1 is supposed to be. As already mentioned above, the assumption is made that the mobile terminal UE1 is located in the mobile radio cell Z1. The mobile terminal UE1 receives the information that there are messages for the mobile terminal UE1 on the notification indication channel PICH, and then receives the notification channel PCH. The mobile communications network transmits a notification on the notification channel PCH, including information which indicates that a multicast message is waiting and the multicast group for which the message is intended. For this purpose, the notification includes an identification of the multicast group, which notification was used to signal to the mobile terminal UE1, such as on entry into the multicast group; to be precise, about the system information. As soon as the mobile terminal UE1 confirms that the identification of the multicast group which it receives on the notification channel PCH matches its own identification, it sets up a signaling link to the node RNC1 in the mobile communications network. In this case, the general physical channel S-CCPCH is set up for the transmission of small amounts of data and for signaling messages from the node RNC1 in the mobile communications network to the mobile terminal UE1, with the subdivided transport format combination identifier TFCI being transmitted on this general physical channel S-CCPCH. The necessary information for configuration of its protocol layers is, in this case, taken by the mobile terminal UE1 from the previously received system information. The mobile terminal UE1 is thus in the RRC CELL_FACH state, which corresponds to the third state MC_Monitoring from FIG. 1.

The node in the mobile communications network RNC1 furthermore knows that the mobile terminal UE2 is located in the mobile radio cell Z1. Now, the node in the mobile communications network RNC1 also transmits information for the mobile terminal UE2 on the notification indication channel PICH in the mobile radio cell Z1 that a notification is being transmitted on the notification channel PCH for the mobile terminal UE2. The mobile terminal UE2 receives the information on the notification indication channel PICH, and then receives the notification channel PCH. The node in the mobile communications network RNC1 then transmits a notification on the notification channel PCH, including information that a multicast message is waiting, and the multicast group for which the message is intended. For this purpose, the information in the notification channel PCH also includes an identification of the multicast group, which would be signaled to the mobile terminal UE2, for example, on entering the multicast group. The mobile terminal UE2 also sets up a signaling link to the node in the mobile communications network RNC1. Prior to this, the identity information in the PCH is compared, with respect to the identity of the multicast group, with the information which may have been signaled on entry into the multicast group.

The general physical channel S-CCPCH likewise is set up in this case for the transmission of small amounts of data and for signaling messages from the node in the mobile communications network RNC1 to the mobile terminal UE2, and the subdivided transport format combination identifier TFCI is transmitted on this physical channel S-CCPCH. The mobile terminal UE2 in this case takes the necessary information for configuration of its protocol layers from the system information. Thus, the mobile terminal UE2 is now in the RRC CELL-FACH state and is in the third state MC_Monitoring (see FIG. 1).

All of the mobile terminals UE1, UE2, UE3 and UE4 in the multicast group A are now in the third state MC_Monitoring and receive the general physical channel S-CCPCH, on which the subdivided transport format combination identifier TFCI is transmitted. The node in the mobile communications network RNC1 now decides what resources in the form of transport channels and physical channels, and which transport format combination TFC, should be used for the transmission of the multicast message. This exemplary embodiment is based on the assumption that both physical channels PMCH1, PMCH2 will be used for the transmission; to be precise, using the transport format combination TFC1. The node in the mobile communications network RNC1, in turn, inserts the transport format combination identifier TFCI2=01 into the two bits of the second data part of the transport format combination identifier TFCI which is transmitted on the general physical channel S-CCPCH. The mobile terminals UE1, UE2, UE3 and UE4 now receive the general physical channel S-CCPCH, whose second data part includes the coding of the transport format identifier, TFCI2. As a result of the system information, the mobile terminals know that the second data part of the transport format combination identifier TFCI, which is transmitted on the general physical channel S-CCPCH, has a length of two bits. The mobile terminals UE1, UE2, UE3 and UE4 use the first data part of the transport format combination identifier TFCI which is transmitted on the general physical channel S-CCPCH in order to pass on the data that is received on the general physical channel S-CCPCH in the relevant transport formats to those transport channels which are mapped onto the general physical channel S-CCPCH. On the basis of the second data part of the transport format combination identifier TFCI which is transmitted on the general physical channel S-CCPCH, the mobile terminals know that data for the multicast group A will be transmitted in the next time frame on the physical multicast channels PMCH1, PMCH2 using the transport format combination TFC1. Those mobile terminals which belong to the multicast group A (in this exemplary embodiment the mobile terminals UE1 to UE4) configure their physical layer in accordance with the configurations which they have taken from the system information. In this case, the transport channel MCH is mapped onto the physical channels PMCH1 and PMCH2.

The configurations of the protocol layers in the mobile terminals UE1 to UE4 and the mapping of the connections between the layers are illustrated in FIG. 3.

Transport channels FACH1, FACH2 which, in this exemplary embodiment, are mapped onto the general physical channel S-CCPCH are combined with the interposition of a demultiplexer De-MUX in a bundle CCTrCH1, an internal channel in the bit transmission layer, which is mapped onto the general physical channel S-CCPCH. The mapping of the connections above the layer MAC onto the transport channels FACH1, FACH2 is of little importance in this case and therefore is not shown in FIG. 3.

The transport channel MCH is combined for the interposition of a multiplexer MUX in a further bundle CCTrCH2, which is then mapped onto the physical multicast channels PMCH1, PMCH2.

The physical channels PMCH1, PMCH2 are sent with a slight time offset to the general physical channel S-CCPCH, as is illustrated in FIG. 4. The time frame R1 for the general physical channel S-CCPCH starts at TS-CCPCH, while the time frame for the two physical channels PMCH1, PMCH2 starts at T_{PMCH}.

The mobile terminals UE1, UE2, UE3 and UE4 in the multicast group A are now in the fourth state MC_Active. As soon as one of the mobile terminals UE1 to UE4 has received the general physical channel S-CCPCH, particularly a specific time frame at the time T_{STCCPCH}, then the mobile terminal receives the physical multicast channels PMCH1, PMCH2 at the time T_{PMCH}. The physical channels PMCH1, PMCH2 are first of all combined in the bundle CCTrCH2. By evaluation of the second data part of the transport format combination identifier TFCI, which was received on the general physical channel S-CCPCH, the transport format combination TFC, which governs the transmission of the multicast message, is determined, and the data in the multicast message can be passed on in an associated transport format via the transport channel MCH to the MAC layer. The data in the multicast message is then passed via a logical channel CTCH and the RNC layer as well as a link V2 to a BMC unit in the BMC layer, as is illustrated in FIG. 3. From there, the multicast message is passed on via a link V1 to an application which processes the multicast message further.

The node in the mobile communications network RNC1 thus may decide from one time frame to another time frame whether and what resources in the form of physical channels and transport channels are allocated to the multicast group A.

If no messages from the multicast group A arrive at the node in the mobile communications network RNC1 in a specific time period, the node in the mobile communications network RNC1 can decide on an individual basis for each of the mobile terminals UE1, UE2, UE3 and UE4 whether that terminal should revert to a more energy-saving state. This exemplary embodiment is based on the assumption that the mobile terminal UE4 still has an individual signaling link, such as a dedicated physical channel PDCH, set up to the node in the mobile communications network RNC1. The mobile terminal UE4 thus remains in the RRC CELL_DCH state, and in the third state MC_Monitoring. If there are still small amounts of data to be transmitted from the node in the mobile communications network RNC1 to the mobile terminal UE3, the node in the mobile communications network RNC1 decides that the mobile terminal UE3 should still remain in the RRC CELL_FACH state. Thus, the mobile terminal UE3 is still in the third state MC_Monitoring. In this exemplary embodiment, no further data is awaiting transmission for the mobile terminals UE1 and UE2. The node in the mobile communications network RNC1 therefore decides that the mobile terminals UE1 and UE2 should change to the RRC CELL_PCH state, and thus transmit a signaling message to the mobile terminals UE1 and UE2 in response to which these terminals clear the signaling link to the node in the mobile communications network RNC1, and change to the RRC CELL_PCH state. The mobile terminals UE1 and UE2 thus enter the second state, MC_Saving.

Although the present invention has been described with reference to specific embodiments, those of skill in the art will recognize that changes may be made thereto without departing from the spirit and scope of the present application as set forth in the hereafter appended claims.

1-6. (canceled).

7. A method for allocation of physical transmission channels in a mobile radio cell, the method comprising the steps of:
providing that the mobile radio cell include a base station which is connected to a node in a mobile communications network and a plurality of mobile terminals;
implementing a UMTS protocol architecture for at least a layer (2) and a layer (3) of a UMTS layer model in the plurality of mobile terminals and in the node in the mobile communications network;
signaling an allocation of a physical transmission channel to one mobile terminal in at least one group of mobile terminals from the plurality of mobile terminals, the signaling occurring by the base station to the one mobile terminal via a general physical channel;
notifying the at least one group of mobile terminals in advance of system information which includes a configuration of the physical transmission channel for the multicast service and of the general physical channel as well as information that the allocation of the physical transmission channel is being signaled on the general physical channel; and
transmitting a continuously updated transport format combination identifier to the at least one group of mobile terminals via the general physical channel, the continuously updated transport format combination identifier indicating which transport channels are being mapped with what transport format combination onto the general physical channel, which mobile terminal would use which physical transmission channel for the multicast service, and which transport channels are being mapped with what transport format combination onto the respective physical transmission channel.

8. A method for allocation of physical transmission channels in a mobile radio cell as claimed in claim 7, wherein the system information includes a code for identifying the at least one group of mobile terminals as a multicast group.

9. A method for allocation of physical transmission channels in a mobile radio cell as claimed in claim 7, wherein the transport format combination identifier is subdivided to include a first data part, which includes a transport format combination identifier for the transport channels which are mapped onto the general physical channel, a second data part, which includes a transport format combination identifier for the transport channels which are mapped onto the physical transmission channel, and a code for identifying the physical transmission channel to be used by a respective mobile terminal.

10. A method for allocation of physical transmission channels in a mobile radio cell as claimed in claim 9, wherein the system information includes a code for allocation of bits of the transport format combination identifier to the first data part and to the second data part.

11. A method for allocation of physical transmission channels in a mobile radio cell as claimed in claim 7, wherein the general physical channel is transmitted at a time before the physical transmission channels.

12. A method for allocation of physical transmission channels in a mobile radio cell as claimed in claim 7, wherein the transport channels which are allocated to the general physical channel are combined in a first bundle in a bit transmission layer, and the transport channels which are allocated to the physical transmission channels are combined in a second bundle in the bit transmission layer.
